(19) United States
(12) Patent Application Publication
(10) Pub. No.: US 2025/0289935 A1
(43) Pub. Date: Sep. 18, 2025

(54) Process for Making Waterborne Polyurethane Sheet with Enhanced Properties

(71) Applicant: Shiue Heng Hsing, Yilan (TW)

(72) Inventor: Shiue Heng Hsing, Yilan (TW)

(21) Appl. No.: 18/602,228

(22) Filed: Mar. 12, 2024

(51) Int. Cl. C08J 7/04; C08G 18/08; C08G 18/10; C08G 18/48

(52) U.S. Cl. CPC C08J 7/042; C08G 18/0866; C08G 18/10; C08G 18/4854; C08J 2375/08

(57) ABSTRACT

A process for making waterborne PU sheet includes: a rubber substrate; a base layer formed with a first waterborne polyurethane dispersion having particle sizes ranging from 200˜300 nm and coated on the substrate; and a surface layer formed with a second waterborne polyurethane dispersion having particle sizes ranging from 1,000˜2,000 nm and coated on the base layer.

### BACKGROUND OF THE INVENTION

A conventional diving or wet suit comprises: a rubber substrate, a base layer of waterborne polyurethane (PU) coated on the substrate, and a surface layer of waterborne polyurethane coated on the base layer.

However, such a conventional diving suit has the following drawbacks:
1. In order to increase the matting effect of the diving suit, a matting agent such as titanium dioxide is incorporated into the waterborne PU dispersion for scattering the incoming light for leading the appearance to be less glossy. However, the matting agent generally formed as particles or powders may cause air pollution to be hazardous to the worker's health in the production factory.
2. Even the surface layer of conventional diving suit is made of nano structure having particle size of PUD ranging from 200˜500 nm for water repellence. Such a conventional surface layer has an upper surface with large friction coefficient to easily break the suit when wearing or take-off.

The present inventor has found the drawbacks of conventional diving suit and invented a process for making a diving suit made of waterborne PU for increasing its properties.

### SUMMARY OF THE INVENTION

The object of the present invention is to provide a process for making waterborne polyurethane sheet adapted for making diving suit having better matting effect and smooth slippery surface. A still object of the present invention is to provide a process for making waterborne PU sheet including: a rubber substrate; a base layer formed with a first waterborne polyurethane dispersion having particle sizes ranging from 200˜300 nm and coated on the substrate; and a surface layer formed with a second waterborne polyurethane dispersion having particle sizes ranging from 1,000˜2,000 nm and coated on the base layer.

### BRIEF DESCRIPTION OF THE DRAWINGS

FIG. 1 shows a gluing roller set as used in the present invention.

FIG. 2 shows process steps for respectively coating the base layer and the surface layer on the rubber substrate to form the PU sheet of the present invention.

### DETAILED DESCRIPTION

First of all, the waterborne polyurethane dispersion (PUD) is prepared as hereinafter described:

Polytetramethylene Ether Glycol (PTMEG, a polyol) and Isophorone diisocyanate (IPDI, an isocyanate) are reacted in the presence of a hydrophilic ion-based internal-phase emulsifying agent phase of Dimethylol Propionic Acid (DMPA) to produce a hydrophobic prepolymer, which is then added with Triethyl Amine (TEA) to react with DMPA to be a hydrophilic ionic state. Then, a large quantity of water, as a dispersing agent, is added therein to obtain the Polyurethane Dispersion (PUD). The particle size of the waterborne PU dispersion plays an important role for matting effect the surface slipping degree of a diving suit so that it is very important to control the quantities of some ingredients in the above-mentioned process.

As shown in FIG. 2, the process comprises the following steps for making the PU sheet:

### Step A

On the rubber substrate 1, selected from: natural rubber (NR), chloroprene rubber (CR), styrene butadiene rubber (SBR), rubber of ethylene propylene diene monomer (EPDM) and thermoplastic rubber (TPR), is coated with a first waterborne polyurethane dispersion on the rubber substrate by a first gluing roller set and then dried to form the base layer 2 on the rubber substrate 1. Step B:

Further coating a second polyurethane dispersion by a second gluing roller set on the base layer 2 to form a surface layer 3 on the base layer coated on the rubber substrate 1.

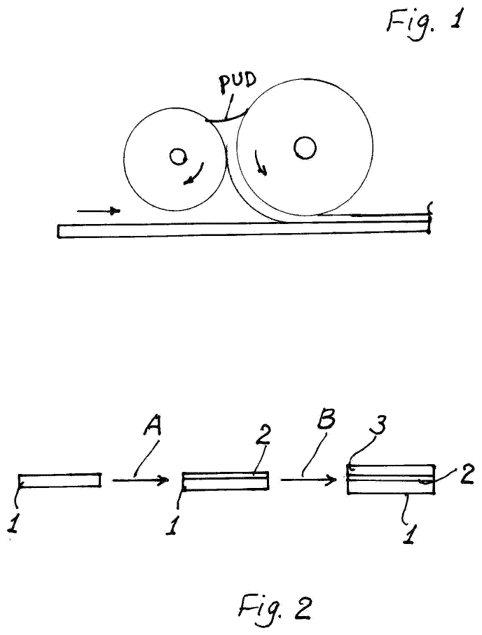

The gluing roller set may be referred to FIG. 1, which is applied thereon with the waterborne PU dispersion (PUD).

In each coating step, an oven or dryer may be provided to dry the base layer and surface layer as coated on the substrate.

For example, in Step A, a small oven (not shown) may be provided for drying the coated substrate, at a temperature of 70˜90° C. for 40˜50 seconds.

In Step B, a large oven (not shown) may be provided to further dry the substrate coated with the base layer and surface layer thereon, at a temperature of 100˜110° C. for 4˜4.5 minutes.

The first waterborne PU dispersion as being applied onto the first gluing roller, has the following formula:
PUD1 1000 g
Hardening agent . . . 30 g
Thickening agent . . . 30 g

While the second waterborne PU dispersion (PUD2) onto the second gluing roller has the following formula:
PUD2 1000 g
Hardening agent . . . 30 g
Thickening agent . . . 30 g
Coloring agent . . . 30 g.

A typical composition (100% by weight) for making PUD of the present invention comprises:
Polyol . . . 71 (weight) %;
Isocyanate . . . 24.8 (weight) %;
DMPA . . . 4.2 (weight) %.

For adjusting the particle size of the waterborne polyurethane dispersion (PUD), the amount DMPA can be adjusted to obtain the desired particle size.

For example,
DMPA % particle size of waterborne PU dispersion
0.5% 1780 nm
1% 930 nm
3% 314 nm
4% 209 nm
5% 141 nm
   in which, DMPA % (by weight) is based on the total amount (100% by weight) of polyol and isocyanate; and in which the Triethyl Amine (TEA) is fixed at 70% (by weight).

TEA may also be varied to adjust the particle size of PUD.

For example, if the DMPA is fixed at 5 (wt) %, the amount of TEA can be adjusted to 90% to obtain the particle size of PUD of 203 nm; or TEA be adjusted to 50% to obtain the particle size of 1002 nm.

The particle size of the waterborne PU dispersion (PUD) of the base layer (2) may be adjusted to be 200˜300 nm to obtain the water repellency of a diving suit as made from the waterborne PU dispersion of the present invention.

The particle size of waterborne PUD of the surface layer (3) may be adjusted to be in the range from 1000˜2000 nm to obtain an uneven surface. Even the particle size may be larger than 2000 nm, a sedimentation will occur to deteriorate the stabilily of the product.

The distribution of particle size of the waterborne PUD on the surface layer (3) is adjusted to be in the range of 1000 through 2000 nm to cause the surface to be uneven, unhomogeneous, and corrugated so as to render the diving suit to have the following advantages:
1. The uneven surface may cause light scattering to have a matting effect, without adding matting agent, to thereby beneficial to human health and environmental protection.
2. The uneven surface of suit will increase the slipping degree of the suit surface, thereby preventing scratching, breaking of the suit when wearing or taking-off the suit.
3. This invention avoids the use of matting agent, which may cause air pollution when added in the reaction to harmfully affect the worker's health. Therefore, this invention is environmentally friendly to be beneficial for worker's health without using the matting agent. Meanwhile, the conventional matting agent, when added, may be easily precipitated to produce white spots, due to unhomogeneous distribution during the processing. However, this invention does not use the matting agent, thereby enhancing the product quality to be superior to the prior art.
   Therefore, the present invention is superior to the conventional processes for making diving suits.

I claim:

1. In preparing a waterborne polyurethane dispersion (PUD) by reacting a polyol with an isocyanate in the presence of Dimethylol Propionic Acid (DMPA), and added with Triethyl Amine (TEA) and water to form a plurality of waterborne polyurethane dispersions, a method for treating at least one said waterborne polyurethane dispersion comprises:
(1) adjusting the amount of DMPA to have a particle size ranging from 200˜300 nm for a first waterborne polyurethane dispersion (PUD1) adapted to be coated on a rubber substrate to form a base layer; and
(2) adjusting the amount of DMPA to have a particle size ranging from 1000˜2000 nm for a second waterborne polyurethane dispersion (PUD2) adapted to be coated on the base layer to form a surface layer;
whereby upon lamination of said surface layer and said base layer on said substrate, a diving suit is formed.

2. In preparing a waterborne polyurethane dispersion (PUD) by reacting a polyol with an isocyanate in the presence of Dimethylol Propionic Acid (DMPA), and added with Triethyl Amine (TEA) and water to form a plurality of waterborne polyurethane dispersions, a method for treating at least one said waterborne polyurethane dispersion comprises:
(1) adjusting the amount of TEA to have a particle size ranging from 200˜300 nm for a first waterborne polyurethane dispersion (PUD1) adapted to be coated on a rubber substrate to form a base layer; and
(2) adjusting the amount of TEA to have a particle size ranging from 1000˜2000 nm for a second waterborne polyurethane dispersion (PUD2) adapted to be coated on the base layer to form a surface layer;
whereby upon lamination of said surface layer and said base layer on said substrate, a diving suit is formed.
